(19) United States
(12) Patent Application Publication
(10) Pub. No.: US 2009/0286459 A1
(43) Pub. Date: Nov. 19, 2009

(54) System and Method to Reduce Thermal Energy in Vehicle Interiors Subjected to Solar Radiation

(75) Inventors: Gregory A. Major, Farmington Hills, MI (US); John I. Frey, Shelby Township, MI (US)

Correspondence Address: Quinn Law Group, PLLC, 39555 Orchard Hill Place, Suite 520, Novi, MI, 48375, US

(73) Assignee: GM Global Technology Operations, Inc., Detroit, MI (US)

(21) Appl. No.: 12/120,925

(22) Filed: May 15, 2008

(51) Int. Cl. B60H 1/24

(52) U.S. Cl. 454/75

(57) ABSTRACT

A system for reducing thermal energy in the interior of an unoccupied vehicle includes an energy source, a temperature sensor, and a control unit which triggers the system in response to satisfaction of conditions. The conditions include the temperature of the passenger compartment being greater than a target temperature and the vehicle engine not running. A fan configured to selectively bring ambient air into the passenger compartment is powerable by the energy source and circulates ambient air through the passenger compartment in response to the control unit. The energy source may include a solar panel or another source characterized by absence of energy derived from the vehicle engine, and excess energy may be distributed to an energy storage device. A seat ventilation fan may operate concurrently with the fan or an HVAC. A method of reducing thermal energy in the interior of a parked vehicle is also provided.

### TECHNICAL FIELD

This disclosure relates to a system and method for reduction of stored thermal energy in vehicle interiors.

### BACKGROUND OF THE INVENTION

Unoccupied vehicles parked in areas exposed to the sun often receive large amounts of solar radiation, which may cause the interior temperature of the vehicle to increase. This may be called a solar soak. Incoming solar radiation from the sun warms thermal masses inside of the vehicle, such as the seats, dashboard, door panels, and console. Air warmed by the heat from hot interior surfaces is retained by the windows and roof, and the interior, therefore, may reach temperatures higher than the temperature of the ambient air outside of the vehicle.

Increased interior air and surface temperatures may be uncomfortable to occupants upon returning to the vehicle. Thus, reducing surface and cushion temperatures will increase comfort on entry.

The temperature increases because solar radiation is able to enter the car but the thermal radiation it creates is not able to escape. Solar radiation causes thermal energy to be stored in the seats and other thermal masses even after the vehicle is no longer parked and retaining thermal energy. The thermal mass of the seats may continue to transfer heat to the occupants for an extended time—often twenty to thirty minutes—after vehicle entry.

Stored thermal energy may be removed once the vehicle is again occupied and running. The occupants often turn on the air conditioner or roll down windows, which may have an effect on the vehicle's fuel efficiency if it takes a significant time period to reduce the stored energy of large thermal masses within the interior.

### SUMMARY

A system is provided for reducing thermal energy in a passenger compartment of an unoccupied vehicle while a vehicle engine is not running. The system includes an energy source and a temperature sensor in thermal communication with the passenger compartment and configured to output a signal representing the temperature of the passenger compartment. A control unit generates a command signal in response to satisfaction of predetermined conditions, which may include: the temperature of the passenger compartment being greater than a predetermined target temperature, and the vehicle engine not running.

A fan is located in fluid communication with ambient air outside of the passenger compartment and configured to selectively bring ambient air into the passenger compartment. The fan is powerable by the energy source and circulates ambient air through the passenger compartment in response to the command signal produced by the control unit.

The energy source may include a solar panel. In one embodiment, the fan may be part of a heating, ventilation, and air conditioning system, such that the ambient air is in fluid communication with the heating, ventilation, and air conditioning system. Variations of the system may include a passenger seat and a seat ventilation fan configured to move air in the passenger compartment into heat exchange relationship with the passenger seat concurrently with circulation of ambient air by the fan or HVAC.

Other applications may include an energy storage device configured to store energy provided by the energy source, and an energy distribution unit configured to selectively divide the provided energy between the energy storage device, fan, and seat ventilation fan. In some embodiments, the energy source is characterized by an absence of energy derived from the vehicle's engine.

A method of reducing thermal energy in the interior of a parked vehicle is also provided. The method may include: A) Sensing whether the vehicle is occupied and whether the vehicle is running; B) monitoring the temperature of the vehicle interior while the vehicle is not running and is unoccupied; C) comparing the monitored temperature to a predetermined target temperature, which may be based upon occupant comfort; D) and, circulating ambient air through the vehicle interior if the monitored temperature is greater than the predetermined target temperature. Some embodiments of the method may include powering the air circulation with energy derived from sources other than the vehicle engine.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic perspective view of a vehicle having roof-mounted solar panels, into which some embodiments of the present invention may be incorporated;

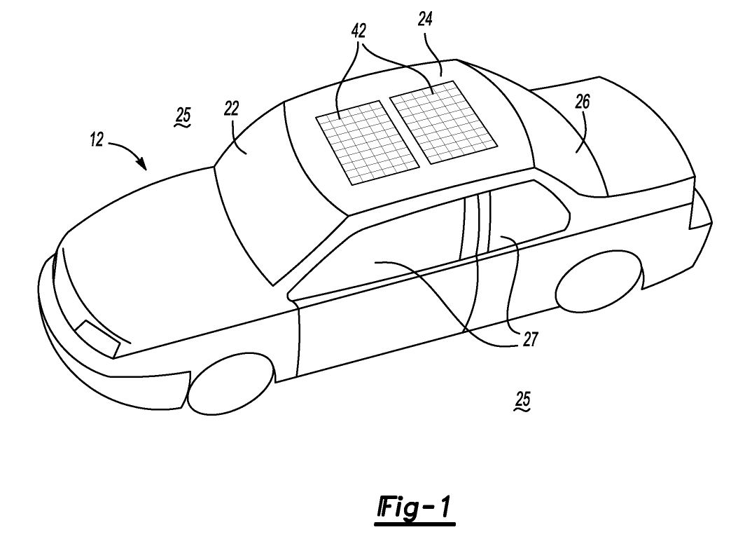

FIG. 2 is a schematic side view of one embodiment of a thermal energy reduction system, shown schematically incorporated into a vehicle; and

FIG. 3 is a flow chart of one embodiment of a method for reducing stored or accumulated thermal energy in an interior or passenger compartment of a parked vehicle.

### DESCRIPTION OF PREFERRED EMBODIMENTS

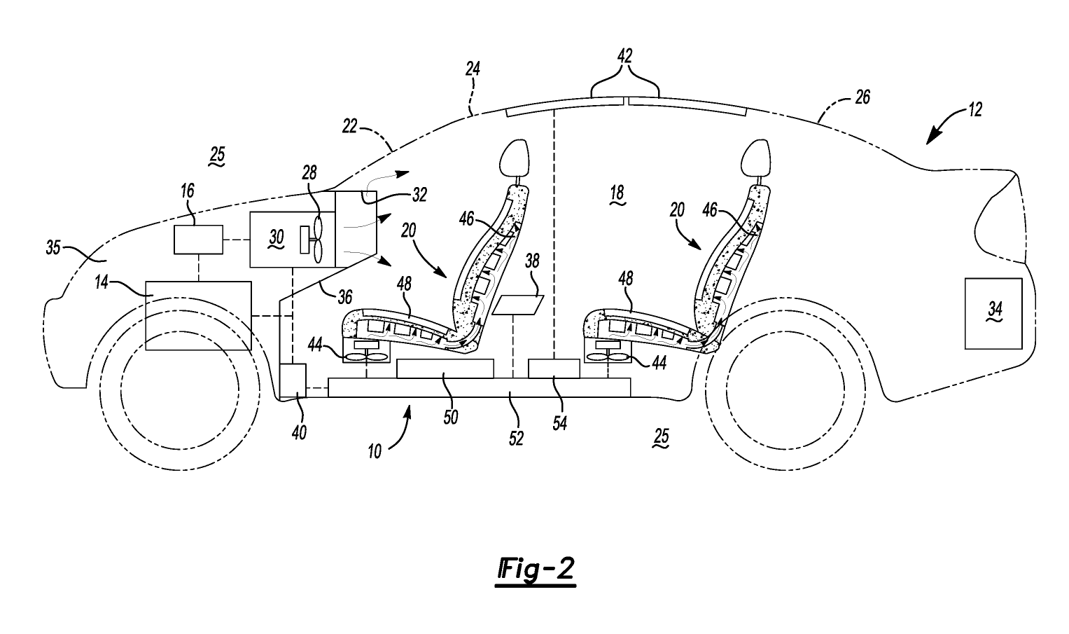

Referring to the drawings, wherein like reference numbers correspond to like or similar components throughout the several figures, there is schematically shown in FIG. 2 an embodiment of a thermal energy reduction system 10 placed in a vehicle 12. Those having ordinary skill in the art will recognize that the thermal energy reduction system 10 may be incorporated into various types of vehicles 12, such as, without limitation: cars, trucks, vans, sport-utility vehicles, et cetera.

Vehicle 12 has an engine 14, which may be an internal combustion engine or another engine, such as, without limitation: an electric propulsion, hybrid, or fuel cell propulsion system, known to those having ordinary skill in the art. While the vehicle 12 is being driven, the engine 14 provides propulsion and generates power which may be stored in a starter battery 16.

As will be recognized by those having ordinary skill in the art, the starter battery may provide multiple functions for vehicle 12, such as starting, lighting, and ignition, and engine 14 may use an alternator (not shown) to charge starter battery 16. In this schematic, engine 14 and battery 16 are shown at the front of the vehicle 12. However, those having ordinary skill in the art will recognize that engine 14 and battery 16—together or individually—could be located in other parts of the vehicle 12.

Much of the space of vehicle 12 is a passenger compartment or interior 18. The interior 18 may include space for occupants and operators of the vehicle 12, cargo storage compartments, and components associated with, and attached to, the passenger compartment. One or more passenger seats 20 are located inside of interior 18.

Those having ordinary skill in the art will recognize that interior 18 is enclosed by numerous members, including, but not limited to: panels of the vehicle exterior or body (not shown), doors (not shown), a front windshield 22, a roof 24, and a rear window 26. The windshield 22, rear window 26, and side windows 27 are usually made from some type of glass or some other transparent or translucent material.

The glass allows incoming solar radiation from the sun to enter interior 18, where it is converted into thermal energy and warms thermal masses of the interior 18. Air warmed by the heat stored in these warmed thermal masses is retained within the interior 18. Therefore, the interior 18 may reach a higher temperature than ambient air 25 outside of the vehicle 12 by allowing solar radiation to enter the interior 18 but preventing the converted thermal energy from convectively escaping interior 18.

Increased thermal energy stored in the air and thermal masses of interior 18 may have several effects on the vehicle 12. Occupant comfort may be affected by the increased air temperature of interior 18. Seats 20 may become uncomfortable for occupants reentering the vehicle 12, and, because of the large thermal mass of the seats 20, this condition may persist for some period of time after the air of interior 18 has reduced in temperature.

As will be recognized by those having ordinary skill in the art, the thermal masses—any material having the ability to store heat—inside of interior 18 will store thermal energy when vehicle 12 is subjected to solar radiation. If this stored energy causes the temperature of interior 18 to become elevated to uncomfortable levels, occupants of the vehicle 12 may take steps to cool the interior 18.

Vehicle 12 includes a fan 28, which may be any type of vent module or blower known to those having ordinary skill in the art. Fan 28 is in fluid communication with ambient air 25 located outside of the vehicle 12 and in fluid communication with the interior 18. Operation of fan 28 pulls ambient air 25 from outside of the vehicle 12 and moves it into interior 18.

In the embodiment shown, fan 28 is part of a heating, ventilation, and air conditioning module 30 (hereinafter HVAC 30) and communicates with interior 18 through a vent or duct 32. However, fan 28 could be installed and operate independently of, or in cooperation with, HVAC 30. An exhaust vent 34 may be provided to improve airflow and circulation—and therefore convective heat transfer—through interior 18 by opening up a clear path between exterior ambient air 25 (the inlet), fan 28, interior 18, and returning to the exterior of vehicle 12 (outlet). Exhaust vent 34 may be in direct fluid communication with the passenger compartment, or may be connected through ducting or any other method known to those having ordinary skill in the art.

The fan 28 may be part of the HVAC 30 air management system, another vehicle system, or a dedicated fan to force air through the vehicle interior 18. Regardless, if the ambient air 25 is at a different temperature than the thermal masses within interior 18, circulation of ambient air 25 through interior 18 will cause a change in the temperature of the thermal masses. As will be recognized by those having ordinary skill in the art, any temperature differential will cause convective and conductive heat transfer between the circulated ambient air 25 and the thermal masses located in interior 18.

HVAC 30 may be located in an engine compartment 35—generally, the area forward of dashboard 36—or may be located in the interior 18. Regardless of its exact location, by virtue of fluid communication with interior 18, the components of HVAC 30 are also thermal masses capable of storing thermal energy brought into the interior 18 by solar radiation.

Those having ordinary skill in the art will recognize that reduction of thermal energy stored in or accumulated by interior 18 requires some form of energy. In many cases, this energy will be supplied by the engine 14 when occupants return to the warmed vehicle 12 and turn on the HVAC 30 as the engine 14 is running. By operating fan 28 or the air conditioner function of HVAC 30, the vehicle's occupants draw power from the engine 14—either directly or through the starter battery 16—to circulate ambient air 25 and/or cooled air through interior 18. In addition to the seats 20, dashboard 36, and HVAC 30, other thermal masses not shown in FIG. 2—such as the trim panels, doors, console, et cetera—will accumulate stored thermal energy that may need to be reduced to improve occupant comfort.

Thermal energy reduction system 10 utilizes the fan 28 to pull ambient air 25 from outside of vehicle 12 and circulate that air through interior 18. A temperature sensor 38 is placed in thermal communication with interior 18. In the embodiment shown schematically in FIG. 2, temperature sensor 38 is located in the passenger compartment of interior 18. However, those having ordinary skill in the art will recognize that temperature sensor 38 could be placed elsewhere in the vehicle 12. Temperature sensor 38 is configured to provide a signal representative of the temperature of the interior 18.

The temperature signal is communicated to a control unit 40. As will be recognized by those having ordinary skill in the art, control unit 40 includes processing or logic capability and memory storage. Control unit 40 may be a stand-alone module, or may be incorporated into a computer (not shown) or ECU (engine control unit) of vehicle 12.

Control unit 40 is configured to receive and process signals indicating the status of multiple variables and determine whether or not to activate thermal energy reduction system 10. Satisfaction of these predetermined conditions notifies the control unit 40 that it is desirable to reduce the thermal energy of interior 18. The predetermined conditions are calculated, individually or collectively, to predict situations in which the temperature of interior 18 is not being actively monitored by occupants of the vehicle 12, such that thermal energy reduction system 10 acts automatically to reduce thermal energy of interior 18.

Some embodiments of thermal energy reduction system 10 may use the ignition switch (not shown) being in the off position, which may indicate that the engine 14 is not running, as a predetermined condition. Other embodiments may disable the thermal energy reduction system 10 while the ignition is on, such as by cutting power to the control unit 40.

One condition monitored by the control unit 40 is the temperature of interior 18, which is compared to a predetermined target temperature. If the actual temperature of interior 18, as measured by temperature sensor 38, is greater than the predetermined target temperature, this may be an indication that it is desirable to reduce the thermal energy of the interior 18 by activating thermal energy reduction system 10.

Control unit 40 may also monitor the operating status of the engine 14. During periods in which the engine 14 is running, it is more likely that the occupants and/or operator of the vehicle 12 are controlling the temperature of interior 18, and the automatic thermal energy reduction system 10 may not be needed. However, when the temperature of interior 18 has increased above a predicted occupant comfort level (the predetermined target temperature) and the engine 14 is not running this indicates that the vehicle 12 may be receiving unwanted solar loads. Additionally, when the engine 14 is not running, there is no power being produced to feed storage battery 16 and accessories —such as the HVAC 30.

Upon satisfaction of the predetermined conditions, control unit 40 sends a command signal to fan 28, to HVAC 30, or to both. The command signal causes fan 28 to begin drawing ambient air 25 from outside of vehicle 12 and moving it through duct 32 into interior 18. Pressure built up by the incoming ambient air 25 forces hot air out of interior 18 and begins circulating ambient air 25 over the thermal masses inside of interior 18. Exhaust vent 34 may assist in this process by opening up a clear path for ambient air 25 circulation. Those having ordinary skill in the art will recognize that multiple exhaust vents 34 may be used and that exhaust vent 34 may be in locations other than the rear of vehicle 12 (as shown in FIG. 2).

Fan 28 or HVAC 30 is in fluid communication with the ambient air 25 outside of vehicle 12. This may be direct or indirect fluid communication. As will be recognized by those having ordinary skill in the art, structure (such as ducts or conduits) may be provided to connect fan 28 or HVAC 30 directly to the ambient air 25. However, the fluid communication may occur indirectly by first pulling air through engine compartment 35 or other components of vehicle 12 to the fan 28 or HVAC 30.

An energy source is needed to power thermal energy reduction system 10. Those having ordinary skill in the art will recognize that the starter battery 16 is one available energy source. Starter battery 16 is often configured to power vehicle accessories, such as the radio, interior lights, HVAC 30, et cetera. However, starter battery 16 has limited energy storage capacity. Furthermore, starter battery 16 derives its energy from the engine 14 and any energy drawn from starter batter 16 needs to be recharged by running engine 14.

An auxiliary energy source, one that does not derive its power from the engine 14, may be provided to power the fan 28 or HVAC 30 of thermal energy reduction system 10. One suitable energy source is a solar panel 42, which may be a single module or multiple modules of linked photovoltaic cells, as would be recognized by those having ordinary skill in the art. Periods of rising interior 18 temperatures caused by trapped solar radiation, may correspond to the availability of solar energy, which is then captured by solar panel 42. Those having ordinary skill in the art will recognize that solar panels 42 may be mounted on a variety of vehicle 12 surfaces, such as, without limitation: the hood, deck lid, fenders, spoiler, et cetera.

An auxiliary energy source allows the thermal energy reduction system 10 to reduce the thermal energy of interior 18 while the vehicle 12 is unoccupied, and does so without using energy produced by running engine 14. Upon returning to vehicle 12, occupants may require less use of the air conditioner (in HVAC 30) to bring interior 18 to comfortable levels. By reducing the need to power the HVAC 30 with engine 14—or energy derived from engine 14—in order to cool interior 18, the vehicle 12 may have improved fuel efficiency.

Seats 20 are large thermal masses within interior 18 and, when hot, may also contribute to discomfort of occupants of vehicle 12. Therefore, it may be beneficial for thermal energy reduction system 10 to include a seat ventilation fan 44 on one or more of the seats 20. The seat ventilation fans 44 increase heat transfer between ambient air 25 circulated by the fan 28 and seats 20, and could be configured to receive a command signal from control unit 40 such that they operate in tandem with air circulation by fan 28 or HVAC 30.

Seat ventilation fans 44 may assist in reduction of thermal energy in one of several ways by moving air in the passenger compartment into heat exchange relationship with the seats 20. By positioning a seat ventilation fan 44 next to a seat 20, airflow may be increased over the seat 20, such that convective heat transfer is increased and the seat 20 cools faster. Alternatively, a seat ventilation fan 44 may be positioned such that it will force airflow through the cushions of seat 20, which may increase the rate at which seat 20 is cooled by circulation of ambient air 25 through interior 18.

In the embodiment shown schematically in FIG. 2, the seat ventilation fans 44 move air through in-seat passageways 46, which increase and direct airflow through the cushions of seats 20, which may be perforated or otherwise configured to assist airflow through the cushions. Seat ventilation fans 44 and in-seat passageways 46 may greatly increase convective and conductive heat transfer from seats 20 to the ambient air 25 being circulated through interior 18. An alternative embodiment (not shown) could link output ducts from HVAC 30 directly to the seats 20, creating a similar effect to seat ventilation fans 44.

Thermal reduction elements—including the seat ventilation fans 44, the fan 28, the HVAC 30, and other elements known to those in the art—operate collectively to reduce the temperature of interior 18 toward the temperature of the ambient air 25 outside of vehicle 12. Those having ordinary skill in the art will recognize other thermal reduction elements which may be incorporated into the claimed invention, such as, without limitation: thermoelectric cooling devices or other refrigeration systems.

Ambient air 25 acts as a large heat sink which thermal energy reduction system 10 may use to selectively reduce the temperature of interior 18. Because temperature is a function of thermal energy, reducing the temperature of interior 18 by transferring heat to circulating ambient air 25 reduces the energy required to subsequently improve occupant comfort on and after vehicle entry.

Seats 20 may also include occupancy sensors 48 configured to produce a signal indicative of whether or not the interior 18 is occupied. Control unit 40 may use this signal and other indications of occupancy to determine that the vehicle 12 is unoccupied. The vehicle 12 being unoccupied may be another predetermined condition required for operation of the thermal energy reduction system 10, and occupancy sensors 48 are one form of structure capable of making such a determination. Those having ordinary skill in the art will recognize numerous types of occupancy sensors 48 which may be incorporated into the thermal energy reduction system 10, such as, without limitation: optical sensors, pressure sensors, sensors of the type used to alter deployment of airbags, et cetera.

Solar energy may be available to solar panel 42 during periods which require no, or partial, operation of the thermal energy reduction system 10. An auxiliary battery 50 may be incorporated into thermal energy reduction system 10 to store energy created by solar panel 42 but not used by fan 28, HVAC 30, or seat ventilation fans 44 to circulate ambient air 25.

An energy distribution unit 52, alone or in cooperation with control unit 40, divides power produced by the solar panel 42 between powering the thermal reduction elements (fan 28, HVAC 30, and seat ventilations fans 44) and charging the auxiliary battery 50. Energy distribution unit 52 may be a separate module or may be incorporated into control unit 40. Auxiliary battery 50 may be a chemical battery or some other energy storage device capable to retaining energy supplied by the solar panel 42 or another auxiliary energy source and then selectively discharging that energy as requested by control unit 40 or energy distribution unit 52.

Some embodiments of the thermal energy reduction system 10 may contain a voltmeter 54, potentiometer, or another device capable of measuring power available for operation of the thermal reduction elements (fan 28, HVAC 30, and seat ventilations fans 44). In this configuration, the predetermined conditions processed by the control unit 40 may include determining that the auxiliary energy sources having a current potential greater than a predetermined minimum potential. This condition operates to ensure that there is enough auxiliary power to operate the fan 28. If the control unit 40 determines that too little energy is available—because, for example, start and auxiliary batteries 16 and 50 are not charged and solar panel 42 is not supplying current—it may be beneficial for the thermal energy reduction system 10 to delay operation until more power is available.

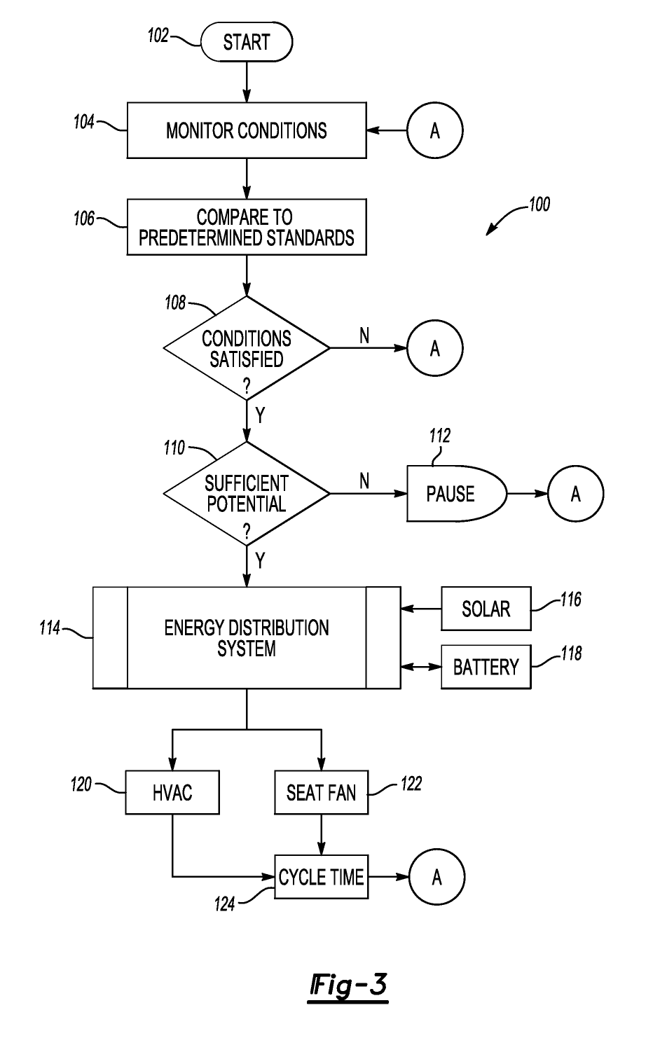

Referring now to FIG. 3, there is shown an embodiment of a method 100 of reducing thermal energy in an interior (18) of a parked vehicle (12). Much of the method 100 may, but need not necessarily, be implemented with the components and elements of the thermal energy reduction system 10 shown schematically in FIG. 2. For descriptive purposes, method 100 is described with reference to elements of thermal energy reduction system 10.

Method 100 begins at an initialization or start step 102. Start 102 may include clearing the memory of control unit 40, and may occur when the ignition switch of vehicle 12 is turned to the off position. Method 100 may also include a corresponding end step or disabling process (not shown) in which the start conditions are reversed and the method 100 is deactivated or cut off regardless of its current status. Those having ordinary skill in the art will recognize that this end step could occur, for example, when the ignition is returned to the on position and power to the components of method 100 is turned off.

Method 100 begins to monitor conditions of the vehicle 12 at step 104, in which control unit 40 begins processing information that will determine whether or not to begin reducing thermal energy of the interior 18. Conditions monitored during step 104 include, but not limited to: interior temperature, operating status of the engine 14, and occupancy of the vehicle 12 by adults, children, or pets.

At step 106, the control unit 40 compares the conditions monitored in step 104 with a set of predetermined standards or target values. Predetermined standards may include, but are not limited to: a minimum temperature below which the system will not operate, the vehicle being unoccupied, the engine not running, and the ignition in the off position. The method 100 next determines whether all of the predetermined conditions have been satisfied in decision step 108. If the conditions have not been satisfied, method 100 returns through return process A to monitoring conditions at step 104. Those having ordinary skill in the art will recognize that return process A may include a pause or may occur constantly, such that steps 104-108 occur simultaneously until all conditions are satisfied.

Once step 108 determines that all conditions have been satisfied, method 100 proceeds to decision step 110 which determines if there is sufficient potential to operate the thermal reduction elements. Those having ordinary skill in the art will recognize that circulation of air with vents, fans, or blowers requires consumption of energy. Step 110 may occur through either a dumb or smart decision process.

Where step 110 uses a dumb process, if the potential of the energy supply is insufficient to operate the equipment (too little power to turn the fan rotors, for example) the thermal reduction elements will fail to operate. In a smart process, the control unit 40 may check the potential of the energy supply and determine whether the potential is above a minimum level, such as that required to operate the control unit 40.

If step 110 determines that there is insufficient potential to operate the thermal reduction elements, method 100 moves to a pause step 112, which is configured to allow time to increase the available energy supply before method 100 cycles back to step 110. In embodiments where the energy source includes an energy storage device (such as storage battery 16 or auxiliary battery 50), the pause step 112 may allow time to recharge. Additionally, pause step 112 may allow time for improvement of current flow from the solar panel 42. Following the pause step 112, method 100 moves through return process A and once again begins monitoring conditions at step 104.

If method 100 determines that the system has sufficient potential in step 110, energy distribution process 114 begins reducing thermal energy in the interior 18. Energy distribution process 114 receives energy from various energy sources (inputs) and distributes or divides that energy between the thermal reduction elements and the energy storage devices (outputs).

The method shown in FIG. 3 includes two inputs into energy distribution process 114: drawing energy from a solar source (solar panel 42) in step 116, and drawing stored energy from an auxiliary battery 50 in step 118. Those having ordinary skill in the art will recognize other possible inputs to energy distribution process 114, such as, without limitation: starter battery 16 or another energy storage device.

The method shown in FIG. 3 includes three outputs: powering HVAC 30 in step 120, powering one or more seat ventilation fans 44 in step 122, or recharging the auxiliary battery 50 in step 118. Note that the auxiliary battery 50 in step 118 may be either an input or output to energy distribution process 114. Those having ordinary skill in the art will recognize other output processes, such as, without limitation, powering the fan 28 or other thermal reduction elements.

Energy distribution process 114 will balance the power needs of the thermal reduction elements with the energy available from the energy sources. If solar panel 42 is producing large amounts of energy but little or no energy is needed to cool interior 18, energy distribution process 114 will output energy to auxiliary battery 50 in step 118 to store the excess energy for later use. However, when the interior 18 is very hot, the solar energy drawn in step 116 may be insufficient to power the thermal reduction elements for an extended period of time. In this case, energy distribution process 114 will draw energy from the auxiliary battery 50 in step 118 to assist in circulating ambient air 25 through interior 18.

Whether the method 100 powers the seat ventilation fans 44 in step 122 or the HVAC 30 in step 120, or both simultaneously, these elements need to run for a sufficient portion of time to affect the temperature of interior 18. Step 124 runs the selected thermal reduction elements for a specific cycle time before returning the method 100 to monitoring conditions in step 104.

Those having ordinary skill in the art will recognize that the duration of each cycle in step 124 may depend upon the specific application and may be either a fixed period or a function of other conditions. For example, step 124 may be configured such that seat ventilation fans 44 and HVAC 30 are always powered for a cycle time duration of one minute. Alternatively, step 124 may vary the cycle time based upon the differential between the temperature of interior 18 and the predetermined standard maximum temperature, such that the thermal reduction elements run for a longer cycle when interior 18 is very hot but only for short bursts when the temperature is close to the predetermined target temperature.

While the best modes and other embodiments for carrying out the invention have been described in detail, those familiar with the art to which this invention relates will recognize various alternative designs and embodiments for practicing the invention within the scope of the appended claims.

1. A system for reducing thermal energy in a passenger compartment of an unoccupied vehicle while a vehicle engine is not running, comprising:
an energy source;
a temperature sensor in thermal communication with the passenger compartment and configured to output a signal representing the temperature of the passenger compartment;
a control unit configured to generate a command signal in response to satisfaction of predetermined conditions including:
the temperature of the passenger compartment being greater than a predetermined target temperature, and
the vehicle engine not running; and
a fan in fluid communication with ambient air outside the passenger compartment and configured to selectively bring ambient air into the passenger compartment in response to said command signal from said control unit, wherein said fan is powerable by said energy source.

2. The system of claim 1, wherein said energy source includes a solar panel.

3. The system of claim 2, wherein said fan is part of a heating, ventilation, and air conditioning system, such that the ambient air is in fluid communication with said heating, ventilation, and air conditioning system.

4. The system of claim 3, further comprising:
a passenger seat; and
a seat ventilation fan configured to move air in the passenger compartment into heat exchange relationship with said passenger seat in response to said command signal from said control unit, wherein said seat ventilation fan is powerable by said energy source.

5. The system of claim 4, further comprising:
an energy storage device configured to store energy provided by said energy source; and
an energy distribution unit configured to selectively divide energy provided by said energy source between said energy storage device, said fan, and said seat ventilation fan.

6. The system of claim 5, wherein said energy source is characterized by an absence of energy derived from the vehicle engine.

7. The system of claim 6, further comprising:
a voltmeter configured to measure the potential of said energy source; and
wherein said predetermined conditions further include said energy source having a present potential greater than a predetermined minimum potential.

8. A vehicle configured to selectively reduce thermal energy while parked, comprising:
an auxiliary energy source;
a temperature sensor in thermal communication with an interior of the vehicle, wherein said temperature sensor outputs an interior temperature signal corresponding to the temperature of said interior;
an engine
a control unit configured to generate a command signal in response to satisfaction of predetermined conditions including:
the temperature of said interior being greater than a predetermined target temperature, and
said engine is not running; and
a heating, ventilation, and air conditioning module configured to selectively bring ambient air into said interior in response to said command signal from said control unit, wherein said heating, ventilation, and air conditioning module is powerable by said auxiliary energy source.

9. The vehicle of claim 8, wherein said auxiliary energy source includes a solar panel.

10. The vehicle of claim 9, further comprising
an occupancy sensor in communication with said control unit and configured to provide a signal indicative of occupancy of the vehicle; and
wherein said predetermined conditions further include said interior being unoccupied.

11. The vehicle of claim 10, further comprising:
a passenger seat; and
a seat ventilation fan configured to move air into heat exchange relationship with said passenger seat in response to said command signal from said control unit, wherein said seat ventilation fan is powered by said auxiliary energy source.

12. The vehicle of claim 11, further comprising:
an energy storage device configured to store energy provided by said auxiliary energy source; and
an energy distribution unit configured to selectively divide energy provided by said auxiliary energy source between said energy storage device, said vent module, and said seat ventilation fan.

13. The vehicle of claim 12, further comprising:
a voltmeter configured to measure the potential of said auxiliary energy source; and
wherein said predetermined conditions further include said auxiliary energy source having a present potential greater than a predetermined minimum potential.

14. A method of reducing thermal energy in an interior of a parked vehicle, comprising:
sensing whether the vehicle is occupied and whether the vehicle is running;
monitoring the temperature of the vehicle interior while the vehicle is not running and is unoccupied;
comparing said monitored temperature to a predetermined target temperature; and
circulating ambient air through the vehicle interior if said monitored temperature is greater than said predetermined target temperature.

15. The method of claim 14, further comprising:
powering a heating, ventilation, and air conditioning module with an auxiliary energy supply, wherein said auxiliary energy supply does not derive energy from the vehicle engine; and
using said heating, ventilation, and air conditioning module for said circulating ambient air through the vehicle interior.

16. The method of claim 15, further comprising:
powering a seat ventilation fan with said auxiliary energy supply; and
blowing air through a passenger seat with said seat ventilation fan while said heating, ventilation, and air conditioning module is circulating ambient air through the vehicle interior.

17. The method of claim 16, wherein said auxiliary energy supply includes a solar panel.

18. The method of claim 17, wherein said auxiliary energy supply includes an energy storage device.

19. The method of claim 18, further comprising selectively distributing power supplied by said solar panel between said heating, ventilation, and air conditioning module, said seat ventilation fan, and said energy storage device.
